(19) United States
(12) Patent Application Publication
(10) Pub. No.: US 2025/0119024 A1
(43) Pub. Date: Apr. 10, 2025

(54) Rotor Embedded Impellers for Axial Flux Machine Cooling

(71) Applicant: Conifer Systems, Inc., Middletown, DE (US)

(72) Inventors: Yateendra B. Deshpande, Sunnyvale, CA (US); Shahzeb Mirza, Sunnyvale, CA (US); Ankit Somani, Sunnyvale, CA (US)

(21) Appl. No.: 18/905,329

(22) Filed: Oct. 3, 2024

Related U.S. Application Data
(60) Provisional application No. 63/542,763, filed on Oct. 5, 2023.

(51) Int. Cl. H02K 9/06; H02K 1/2798; H02K 9/22

(52) U.S. Cl. CPC H02K 9/06; H02K 1/2798; H02K 9/227

(57) ABSTRACT

Systems and methods related to rotor embedded impellers for axial flux machine cooling are disclosed herein. An axial flux electric machine may include a stator, a rotor spaced apart from the stator in an axial direction of the axial flux electric machine to form an air gap, and at least one impeller on the rotor, where the at least one impeller includes a rotor gap through the rotor and an airfoil element. Specific embodiments of the present application can efficiently cool an axial flux electric machine to allow for higher torque and power generation for the same base axial flux electric motor design (e.g., the same cost and volume). These embodiments provide a simple and effective method to extract heat from an axial flux electric machine by creating pressure drops and fluid flow patterns within the motor cavity.

### CROSS REFERENCE TO RELATED APPLICATIONS

This application claims the benefit of U.S. Provisional Patent Application No. 63/542,763, filed Oct. 5, 2023, which is incorporated by reference herein in its entirety for all purposes.

### BACKGROUND

Axial flux electric machines were first patented in U.S. Pat. No. 405,858 by Nikola Tesla in 1889. However, the usage of such machines in commercial space had been largely rare until the invention of the high-performance Neodymium-Iron-Boron (Nd—Fe—B) permanent magnet material in 1983. Since then, axial flux electric machines have gained widespread adoption on rapid scale due to their high efficiency and compact nature as compared to other technologies. The emergence of environmentally friendly technologies like electric vehicles have further boosted the application space of axial flux electric machines. Today, axial flux electric machines are used in electric vehicles, robots of various sizes and types, and electric or hybrid propulsion systems for aircraft. It is generally desirable to reduce the power losses produced in electric machines to thereby improve the machines' energy conversion efficiency. It is also desirable to keep electric machines lightweight and compact and to reduce their upfront manufacturing costs.

Axial flux electric machines typically comprise a stationary assembly and a rotating assembly. In its most basic form, an axial flux electric machine comprises at least three parts: a stator, a rotor, and a rotor shaft. Stators are stationary parts, whereas rotors and rotor shafts are rotating parts. An axial flux electric machine can also include more than one stator or more than one rotor. Two examples of axial flux electric machines are shown in FIG. 1. Axial cross section 100 shows an axial flux electric machine having one rotor and two stators and axial cross section 110 shows an axial flux electric machine having one stator and two rotors. Radial cross section 111 shows a stator in either axial flux electric machine. Radial cross section 112 shows a rotor in either axial flux electric machine. The axial flux electric machine functions by exchanging electric energy and the rotational energy of the rotating parts using a magnetic field that is in the direction of rotation of the rotating parts.

The manner in which electrical energy and rotational momentum are exchanged in an axial flux electric machine depends on the specific design of the machine. With respect to axial flux electric motors, the design can include permanent magnets and controllably magnetized magnets. The permanent magnets can be on the rotor or the stator and the controllably magnetized magnets can be on either the rotor or the stator. Stator 101 and rotor 102 can be the stators and rotors on the two different kinds of illustrated axial flux electric machines as illustrated in FIG. 1. In the provided examples, the permanent magnets are on the rotor while the stator can be controllably magnetized to rotate the rotor. However, in alternative examples, the permanent magnets are on the stator and the rotor can be controllably magnetized.

The controllably magnetized magnets can include conductive coil windings and soft magnetic material. In the axial flux electric machines of FIG. 1, the stator comprises coil windings 105 wherein the coils are made of conductive material, and terminals of the electrically conductive coils are exposed externally to be energized by an external electrical circuit. Typical conductive materials for coils are aluminum and copper. As shown in FIG. 1, a conductive wire is coiled around a trapezoidal shaped pole piece 106 to form coils windings 105. Such pole pieces are manufactured using complicated molding processes using soft magnetic materials and laminations. The soft magnetic material is what allows the device to be configurable magnetized under the influence of current applied to the coiled wire. As shown in axial cross section 100, portions of the axial flux electric machine (e.g., rotor 102, permanent magnets 103, coil windings 105, pole piece 106) may be contained within motor housing 107.

The rotor can be connected to a rotor shaft to transfer the rotational momentum of the rotor to an external system. As illustrated in FIG. 1, a rotor can house a circular array of specifically spaced, alternating pole, permanent magnets 103 and be coupled to rotor shaft 109. The rotor is typically supported by one or more bearings 108 that allow rotation of the rotor about an axis of rotation while maintaining a substantially uniform air gap between the rotor and stator. In the example of an axial flux motor in accordance with the examples in FIG. 1, when the coils of the stator are energized, the current flowing through the coils generates magnetic fields between two adjacent coils having opposite polarities, which alternate, and the magnetic flux generated by the coils repels or attracts a permanent magnet close to them, inducing torque and rotation of the rotor. The rotor shaft coupled to the rotor, in turn, transfers the torque to an externally connected load.

### SUMMARY

Electric machines that convert electrical power to rotational mechanical power or vice versa and associated methods and systems are disclosed herein. The electrical machines may be permanent magnet synchronous AC electric machines in the form of axial flux electric machines. The axial flux electric machines may be either motors or generators. The axial flux electric machines may be yokeless axial flux electric machines.

One drawback to prior art axial flux electric machines is that there is little heat dissipation from the energized portion of the motor (e.g., the stator in the examples of FIG. 1). This low heat dissipation is caused by the insulating layer of air in the air gap between the rotor and the stator. This causes problems in the form of a decreased maximum operating speed of the axial flux electric machine and the potential for damage to the elements of the machine. This is also a difficult problem to fix because machines with arbitrarily small air gaps are a serious manufacturing challenge.

With the advent of high-power density and high energy density battery systems, more and more electric motors are used in various mobility and robotics applications. These applications demand that the motor be highly compact, efficient, and cost effective. In most applications, the largest source of heat in the drive system is the joule heating due to current passing through the stator windings. Additionally, the motors are sealed from the outside environment to protect the windings, magnets, and bearings from damage due to dust, debris, ferrous particles. As the motor is sealed, it is even more difficult for heat to dissipate from the system. As a result, temperature limits on insulation materials between stator windings limit the maximum power and torque achievable for a specific machine geometry.

Specific embodiments of the present application can efficiently cool an axial flux electric machine to allow for higher torque and power generation for the same base axial flux electric motor design (i.e., the same cost and volume). These embodiments provide a simple and effective method to extract heat from an axial flux electric machine by creating pressure drops and fluid flow patterns within the motor cavity.

In specific embodiments of the invention, an axial flux electric machine is provided. The axial flux electric machine comprises a stator, a rotor spaced apart from the stator in an axial direction of the axial flux electric machine to form an air gap, and at least one impeller on the rotor. The at least one impeller can include a rotor gap through the rotor and an airfoil element.

In specific embodiments of the invention, an axial flux electric machine is provided. The axial flux machine comprises a stator, a rotor spaced apart from the stator in an axial direction of the axial flux electric machine to form an air gap, a rotor shaft attached to the rotor, and a fan attached to the rotor shaft and to the rotor.

In specific embodiments of the invention, a method for cooling an axial flux electric machine is provided. The method comprises rotating a rotor relative to a stator, the rotor being spaced apart from the stator in an axial direction of the axial flux electric machine to form an air gap. The rotor comprises a set of impellers. The method further comprises forming, using the set of impellers and based at least in part on rotating the rotor, a pressure gradient across a surface of the rotor.

As used herein, the term “radial surface area” refers to a surface measured perpendicular to the axial direction of the axial flux electric machine. As used herein the term “radial cross section” refers to the view provided by looking at the axial flux electric machine in the direction of the axis of the axial flux electric machine and the term “axial cross section” refers to the view provided by looking at the axial flux electric machine in-line with a radius of a rotor of the axial flux electric machine.

### BRIEF DESCRIPTION OF THE DRAWINGS

The accompanying drawings illustrate various embodiments of the systems, the methods, and various other aspects of the disclosure. A person with ordinary skills in the art will appreciate that the illustrated element boundaries (e.g., boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 illustrates axial flux electric machines in accordance with the related art.

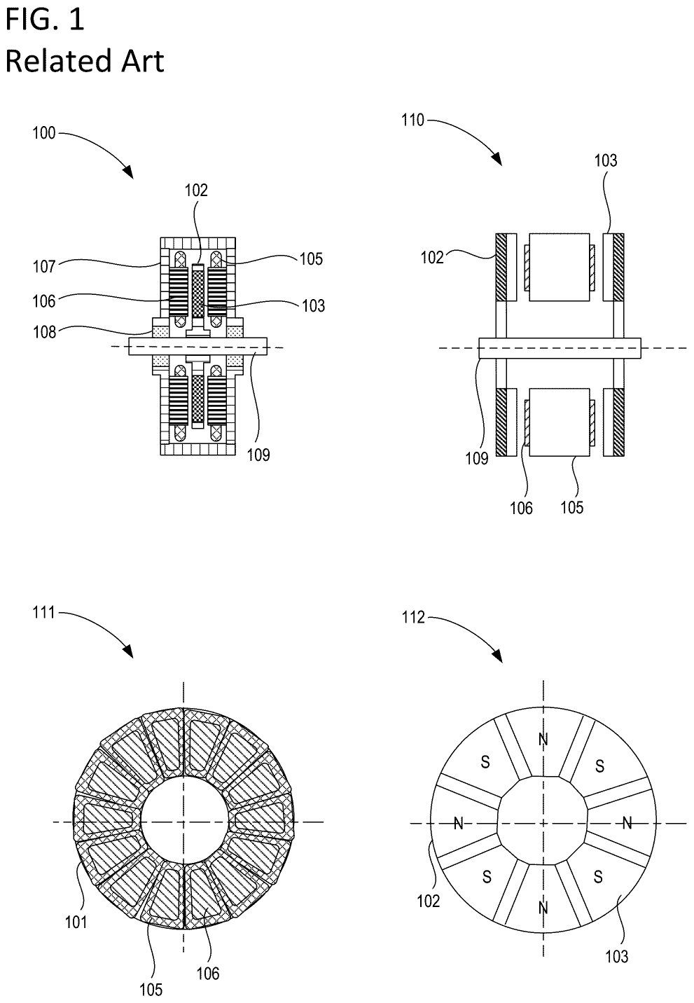

FIG. 2 illustrates an example of a rotor in accordance with specific embodiments of the invention.

FIG. 3 illustrates an example of a rotor with three impeller blades in accordance with specific embodiments of the invention.

FIG. 4 illustrates a radial cross section of a rotor showing the details of an impeller in accordance with specific embodiments of the invention.

FIG. 5 illustrates a radial cross section of two rotors and a stator along with a plot of pressure values at various positions in the cross section in accordance with specific embodiments of the invention.

FIG. 6 illustrates two radial cross section of two rotors and a stator showing how the direction of rotation of the rotor impacts the direction of airflow in accordance with specific embodiments of the invention.

FIG. 7 illustrates a radial cross section of two rotors and a stator showing the direction of airflow through the system while the two rotors are rotating in accordance with specific embodiments of the invention.

FIG. 8 illustrates a radial cross section of two rotors and a stator showing the direction of airflow through the system while the two rotors are rotating in an opposite direction to that of FIG. 7 in accordance with specific embodiments of the invention.

FIG. 9 illustrates a rotor with impellers in the form of windows and airfoil elements comprising chamfered edges of the windows in accordance with specific embodiments of the invention.

FIG. 10 illustrates a rotor with impellers in the form of windows and airfoil elements comprising chamfered edges of the windows and chamfered channels that extend from the windows to an outer edge of the rotor in accordance with specific embodiments of the invention.

FIG. 11 illustrates a rotor with segmented magnets and impellers in the form of windows and airfoil elements that extend from a center of the rotor towards an outer edge of the rotor and between the magnets in the set of segmented magnets in accordance with specific embodiments of the invention.

FIG. 12 illustrates a rotor with impellers in the form of windows and airfoil elements that extend from the rotor in a direction that is away from the stator in accordance with specific embodiments of the invention.

FIG. 13 illustrates a rotor that is double sided where a rotor gap extends through both sides of the rotor into a cavity with airfoil elements extending from the center of the rotors to the outer edges of the rotors. The outside edge of the rotor includes at least one window for the cavity in accordance with specific embodiments of the invention.

FIG. 14 illustrates a rotor with segmented magnets and impellers in the form of windows and airfoil elements comprising chamfered edges surrounding the windows in accordance with specific embodiments of the invention.

FIG. 15 illustrates a radial cross section of a motor assembly having two rotors on either side of a stator and attached to a rotor shaft in accordance with specific embodiments of the invention.

FIG. 16 illustrates a radial cross section of a motor assembly having two stators each with a pair of rotor magnets in accordance with specific embodiments of the invention.

FIG. 17 illustrates a radial cross section of three rotors on either side of two stators and attached to a rotor shaft in the form of a tandem axial electric motor showing the direction of airflow through the system while the three rotors are rotating in accordance with specific embodiments of the invention.

FIG. 18 illustrates a method for cooling an axial flux electric machine in accordance with specific embodiments of the invention.

### DETAILED DESCRIPTION

Reference will now be made in detail to implementations and embodiments of various aspects and variations of systems and methods described herein. Although several exemplary variations of the systems and methods are described herein, other variations of the systems and methods may include aspects of the systems and methods described herein combined in any suitable manner having combinations of all or some of the aspects described.

Methods and systems related to axial flux electric machines in accordance with the summary above are disclosed in detail herein. The methods and systems disclosed in this section are nonlimiting embodiments of the invention, are provided for explanatory purposes only, and should not be used to constrict the full scope of the invention. It is to be understood that the disclosed embodiments may or may not overlap with each other. Thus, part of one embodiment, or specific embodiments thereof, may or may not fall within the ambit of another, or specific embodiments thereof, and vice versa. Different embodiments from different aspects may be combined or practiced separately. Many different combinations and sub-combinations of the representative embodiments shown within the broad framework of this invention, that may be apparent to those skilled in the art but not explicitly shown or described, should not be construed as precluded.

Electric motors for mobility applications typically operate in local air ambient temperatures ranging from −40 Celsius to +65 Celsius. Within motor windings, insulation layers separate winding turns from each other. This insulation layer can be made of polymeric organic material, which has a temperature endurance limit of somewhere between 120 Celsius to 240 Celsius depending on the actual material used. If this limit is exceeded repeatedly or for extended periods, then the insulation can fail resulting in shorting between motor winding turns and ultimately motor failure. Additionally, when conductor temperature increases, the resistivity of the conductor increases as a function of temperature (approximately 0.39% per degree Celsius for copper) further increasing joule losses. For these reasons, effective heat extraction from the motor is important to achieve higher power density and torque density in electric motors.

A challenge with air-cooled yokeless axial flux motors is that the stator is not in direct thermal contact with the housing and is separated from the housing by air. Air is not a good conductor of heat. Therefore, use of the motor can result in a high temperature rise in stator. However, effective airflow can achieve a high convection coefficient and heat transfer via circulating air within the motor cavity. This is particularly true for high-speed operation of the motor. For instance, a 140-millimeter (mm) diameter rotor spinning at 12,000 rotations per minute (RPM) has a tip velocity of approximately 88 meters per second. This leads to local turbulence in the air gap between the stator and rotor. A typical air gap between the stationary surface of the stator and rotating surface of the rotor is 0.4 mm to 1.5 mm depending on the overall motor configuration.

In specific embodiments of the invention, various techniques are utilized to increase the airflow through a motor assembly and to increase the effective thermal conductivity of the system to move heat away from the air gap and out of the motor assembly. In specific embodiments, a fan can be attached to the rotor shaft, to the rotor, or to the rotor and the rotor shaft. The fan can increase airflow through the motor housing when the rotor spins. In specific embodiments, a set of thermal features can be formed on the motor housing which are configured to increase turbulence of the airflow within the motor housing and to increase a surface area of the motor housing to increase the thermal conductivity of the motor assembly for removing heat from the motor. The set of thermal features can be fins or pins that extend out from a surface of the motor housing towards the rotor(s) and stator(s). The fins or pins may be straight or curved. In specific embodiments, the thermal features may be dimples in the motor housing. In specific embodiments, a set of airfoil guide elements can be formed on the motor housing. The set of airfoil guide elements can be configured to guide air towards the air gap to increase the amount of air that circulates through the air gap. For example, the airfoil guide elements can be a series of airfoils that are progressively taller and extend closer to the rotor shaft in a direction moving from the back side of a rotor towards the air gap. In specific embodiments, one or more rotors of an axial electric machine can each include at least one impeller. The impeller can include a rotor gap through the rotor and an airfoil element. The impeller can be configured to form a pressure drop across a surface of the rotor when the rotor rotates. The pressure drop can cause air to flow from outside of the air gap between the rotor and the stator, through the air gap, and through the rotor gap, or back in the opposite direction. In either event, the result will be cooling of the stator using thermal convection as the air passes through the air gap.

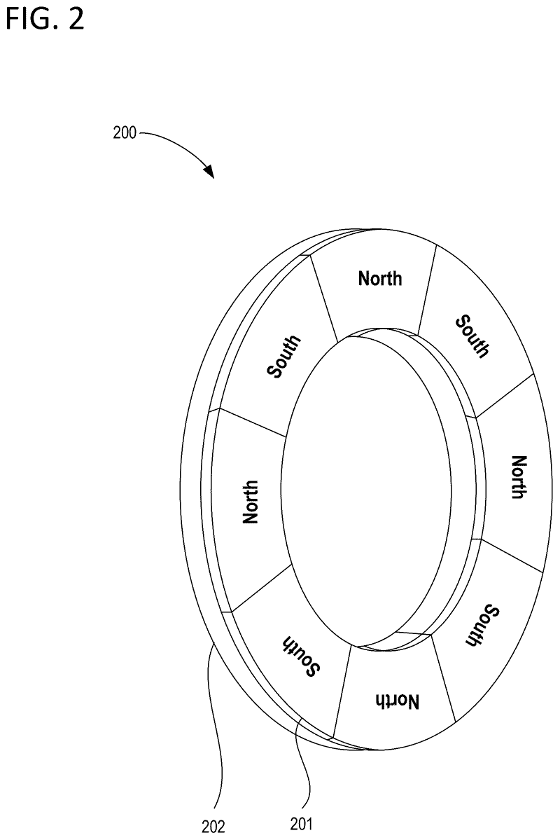

FIG. 2 illustrates a rotor 200 that can be used in accordance with specific embodiments of the invention. Permanent magnetic disc 201 is attached to rotor support structure 202, which provides mechanical support to permanent magnetic disc 201. Permanent magnetic disc 201 is magnetized in a way to create a substantially axial magnetic field with alternating north and south magnetic poles. In another embodiment, permanent magnetic disc 201 is achieved by joining a plurality of permanent magnets together or joining a plurality of permanent magnets to rotor support structure 202. In either embodiment, it is not necessary that the permanent magnets fill the entirety of the volume of permanent magnetic disc 201 as depicted in FIG. 2. Rotor support structure 202 may be attached to rotor shaft in a way that allows for transmission of torque without relative movement at the contact surface between the rotor shaft and rotor support structure 202 and allows for all parts of rotor 200 to spin at the same rotational velocity about the axis defined by the support bearings of rotor 200.

In specific embodiments, the impellers can take on various forms and be implemented on rotors (such as rotor 200) in various ways. The impellers can include a rotor gap through the rotor. The rotor gap can be a hole through the rotor that is enclosed on four sides by rotor material or a channel through the rotor that is only enclosed on three sides by rotor material. The rotor gaps can extend through the back iron (e.g., rotor support structure 202) of a rotor through to the air gap formed by the rotor (e.g., between the rotor and a stator). In specific embodiments, the rotor gap may include two separate gaps through two faces of the rotor with a cavity between the two separate gaps. The cavity can be unique to the rotor gap or shared with other rotor gaps. The two separate gaps still form a rotor gap even if they are not aligned in a radial direction or along an axial surface area of the rotor so long as there is a continuous fluid path through the two separate gaps from a backside of the rotor through to the air gap side of the rotor. Using any of these approaches, and those shown in the figures below, the rotor gap can be configured to form a fluid path from the air gap to a back iron side of the rotor or vice versa.

In specific embodiments, there can be one or more rotor gaps on a rotor (e.g., rotor 200) and the rotor gaps can be positioned in various ways. The rotor gaps can be positioned in various places along the radius of the rotor and along an arc of the rotor. In specific embodiments, the rotor gap will be placed along the radius close to the center of the rotor as this may provide the maximum surface area through the air gap for the fluid flow to transfer heat from the air gap. Having the rotor gap placed close to the center of the rotor may provide the maximum surface area through the air gap because there may be a single (e.g., non-sectioned) magnet that takes up space on the outer sections of the rotor. The rotor gaps can be placed adjacent to a central support structure of the rotor which attaches the rotor to the machine shaft of the axial electric machine. In specific embodiments, a rotor gap will take up over 5 degrees of an arc of the rotor. There can be various numbers of rotor gaps on the rotor including 2, 4, 6, and more rotor gaps. In specific embodiments, the rotor gaps can occupy, in total, at least ninety degrees of an arc of the rotor. In specific embodiments, the rotor gaps can be evenly distributed around an arc of the rotor to distribute the impact of each gap on the structural strength of the rotor and to minimize the average mean square distance between the rotor gaps and the various portions of the axial surface of the stator to provide for evenly distributed thermal conductivity to the surface of the stator.

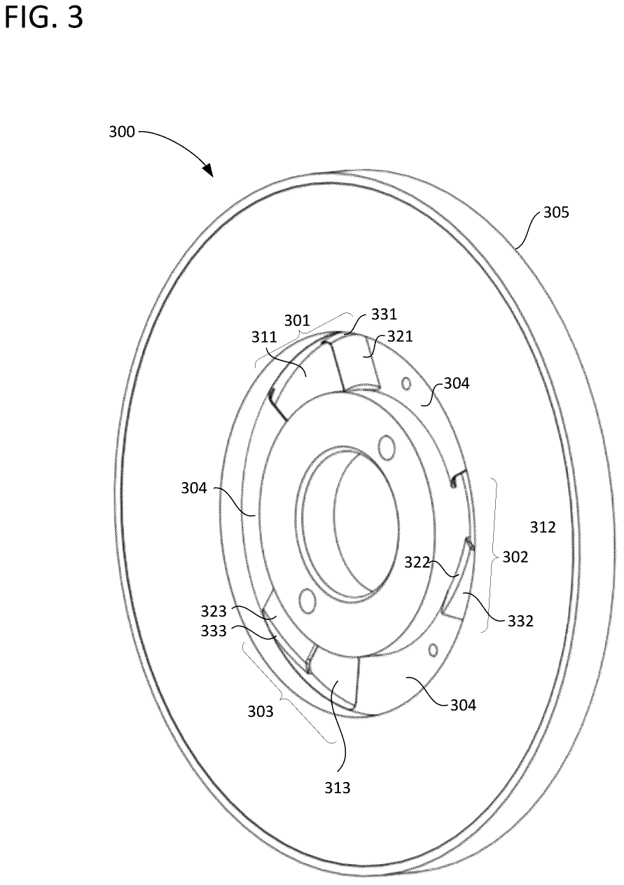

FIG. 3 illustrates an example of rotor 300 with three impellers (301, 302, and 303), and three associated rotor gaps (311, 312, and 313 respectively) which comprise windows through rotor 300. Rotor 300 may be part of an axial flux machine that also includes a stator. In this example, rotor gaps 311, 312, and 313 comprise windows that occupy over thirty degrees of an arc of rotor 300. Between impellers 301, 302, and 303 there is support structure 304. Impellers 301, 302, and 303 also include airfoil elements 321, 322, and 323, respectively. Airfoil elements 321, 322, and 323 may be chamfered edges (e.g., vary in thickness, be slanted or angled) between support structure 304 and corresponding rotor gaps 311, 312, and 313. Airfoil elements 321, 322, and 323 may include chamfered channels (e.g., leading edges) 331, 323, and 333, respectively. Airfoil elements may also be referred to as airfoil guide elements. Airfoil elements 321, 322, and 323 may guide air towards an air gap. Rotor 300 may include aspects of rotor 200.

In specific embodiments of the invention, the number of rotor gaps and the size of each rotor gap is selected to balance increased airflow against stability of the rotor. In a basic example, the rotor gaps cannot occupy a full 360 degrees of the arc of the rotor because then there would be no material in contact with the machine shaft. Furthermore, when the rotor spins at its maximum velocity, the rotor undergoes considerable centripetal force which would pull the rotor apart if insufficient structural rotor material (e.g., support structure 304) attaches the outer portion of the rotor to the machine shaft. Accordingly, the portions of the rotor material (e.g., support structure 304) that are left can be thickened relative to their usual dimensions to increase the tensile strength of those portions of the rotor. As the rotor gaps (e.g., rotor gaps 311, 312, and 313) represent material that would otherwise have contributed to the weight of the rotor, this thickening can be done without increasing the weight of the rotor relative to an identical rotor without rotor gaps. In specific embodiments of the invention, the rotor gaps should not, in total, occupy more than 180 degrees of the arc of the rotor and no individual rotor gap should occupy more than 45 degrees of the arc of the rotor.

Airfoil elements 321, 322, and 323 and rotor gaps 311, 312, and 313 may have been etched into rotor 300. As illustrated, rotor gaps 311, 312, and 313 comprise windows through back iron 305 of rotor 300. In alterative embodiments, the airfoil elements can be separate pieces attached to the rotor. Leading edges (e.g., chamfered channels) 331, 332, and 333 may be carved down into the surface of rotor 300 such that they extend away from the stator.

In the example of rotor 300, each impeller comprises a rotor gap (that comprises a window) and an airfoil element (that comprises a chamfered edge of the window and a chamfered channel that extends around the arc of the rotor). An impeller, such as impeller 301, is a feature of a rotor configured to form a pressure drop across a surface of the rotor when the rotor rotates. The pressure drop can cause air to flow from outside of the air gap between the rotor and the stator, through the air gap, and through the rotor gap, or back in the opposite direction. In either direction, the result will be cooling of the stator using thermal convection as the air passes through the air gap. Impellers 301, 302, and 303 may increase air circulation, increase heat transfer to a casing housing rotor 300, and cool the associated axial flux machine (e.g., stator(s), rotor(s)). In specific embodiments, leading edges 331, 332, and 333 may increase airflow (e.g., may assist in scooping air).

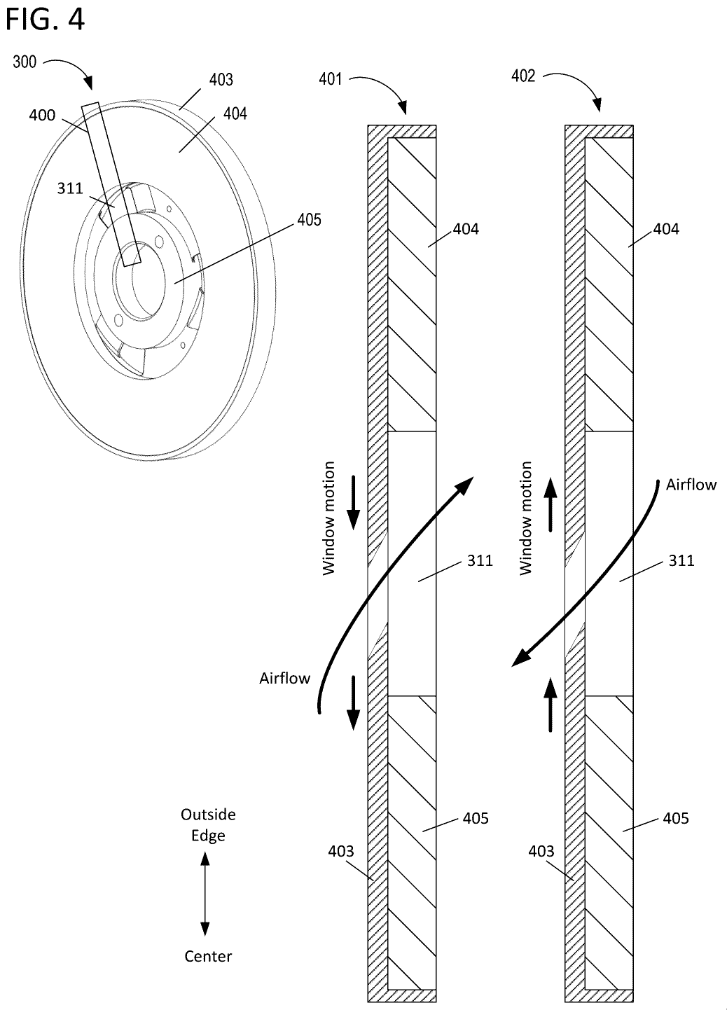

In specific embodiments, the airfoil elements of the air gap can take on various forms. FIG. 4 provides an example of radial cross section 400 of rotor 300. Rotor 300 may be part of an axial flux machine that also includes a stator. Radial cross section 400 includes airfoil element 321 in the form of a chamfered edge of rotor gap 311. Radial cross section 400 includes a portion support structure 403, a portion of outer disc 404, and a portion of inner disc 405. As illustrated, the motion of rotor 300 will result in airflow in one of two different directions, as shown in rotation 401 and rotation 402. However, regardless of the direction of airflow, the result will be air moving across the surface of the stator and through the air gap. For example, rotation 401 causes air movement from the center to the outer edge and rotation 402 causes air movement from the outer edge to the center.

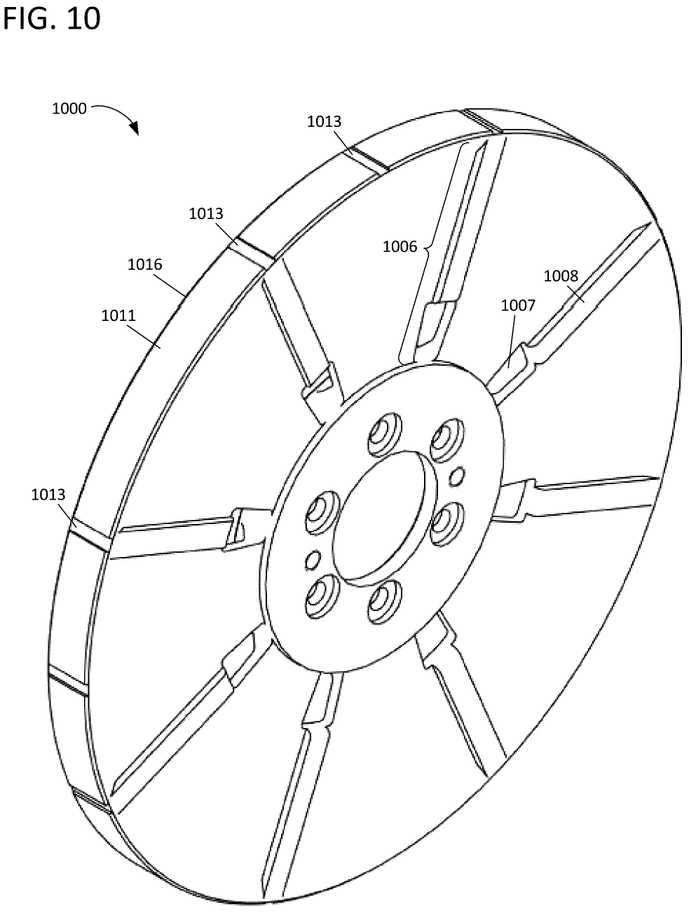

The airfoil elements can be chamfered edges of a window or chamfered edges of the rotor gap. The airfoil elements can include, in the alternative or in combination, a channel formed in or on the rotor with a surface in the shape of an airfoil. In the example of FIG. 3, each impeller comprises a rotor gap that comprises a window and an airfoil element that comprises a chamfered edge of the window and a chamfered channel that extends around the arc of the rotor. In the example of FIG. 10, each impeller comprises a rotor gap that comprises a window and an airfoil element that comprises a chamfered edge of the window and a chamfered channel that extends from the window towards an outer edge of the rotor. More particularly, in the example of FIG. 10, the channel extends to an outer edge of the rotor. The channels and chamfered edges could extend either in the radial direction of the rotor, around the arc of the rotor, or both.

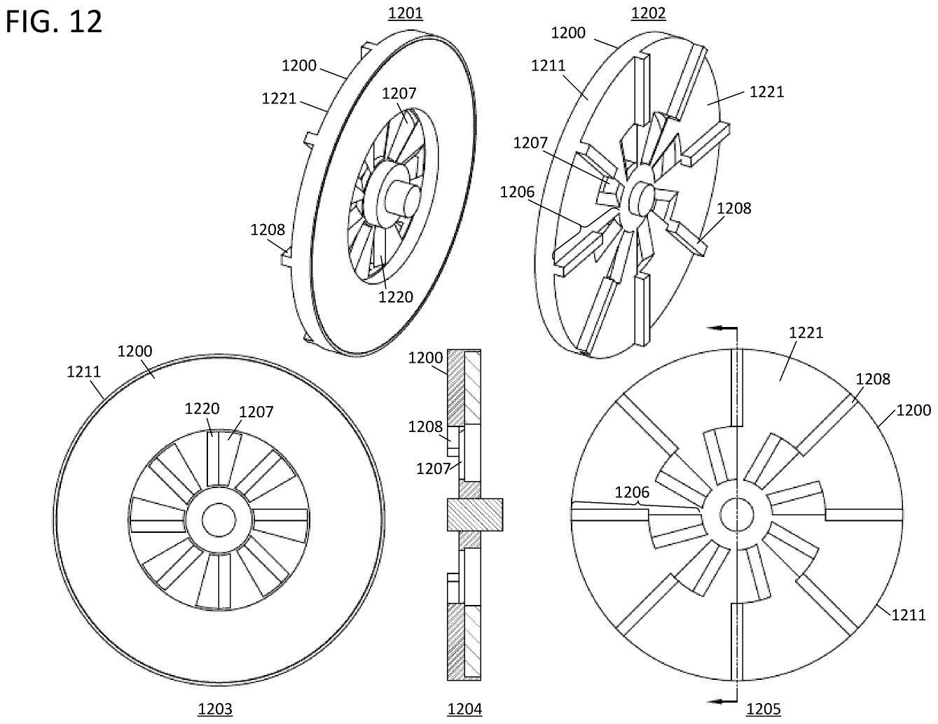

In specific embodiments, the rotor gaps and airfoil elements can be formed in various ways. For example, the rotor gaps and the airfoil elements can each be formed on the rotor. The airfoil elements and rotor gaps can be etched into the rotor, stamped out of the rotor using a press, or formed by a mold that is used to form the rotor. In the example of FIG. 3, both the airfoil elements and the rotor gaps have been etched into the rotor. As illustrated, the rotor gap comprises a window through the back iron of the rotor. In alterative embodiments, the airfoil elements can be separate pieces attached to the rotor. For example, a rotor gap of an impeller could be formed on the rotor and the airfoil element of the impeller could be attached to the rotor. The airfoil elements can be formed or attached to the rotor at various places. For example, the airfoil element could comprise an airfoil on an outer edge of the rotor. The airfoil elements, whether formed in the rotor or attached to the rotor, can extend in a direction that is away from the stator. For example, the channels in FIG. 3 are carved down into the surface of the rotor such that they extend away from the stator. As another example, the airfoil elements formed on the back side of the rotor in FIG. 12 extend away from the stator. Airfoil elements that extend away from the stator leave the air gap free of obstructions that would limit airflow through the gap and prevent the possibility for elements being too close to the stator for manufacturing tolerances to assure no contact between the stator and rotor.

In specific embodiments of the invention, the airfoil elements can be configured to form a pressure gradient across a surface of the rotor when the rotor rotates. In specific embodiments, the rotor gap can be configured to form a fluid path from the air gap to a back side of the rotor (e.g., a back iron side of the rotor). In combination, the features will force air through the air gap along a path extending in a radial direction along a surface of the stator, cooling the stator.

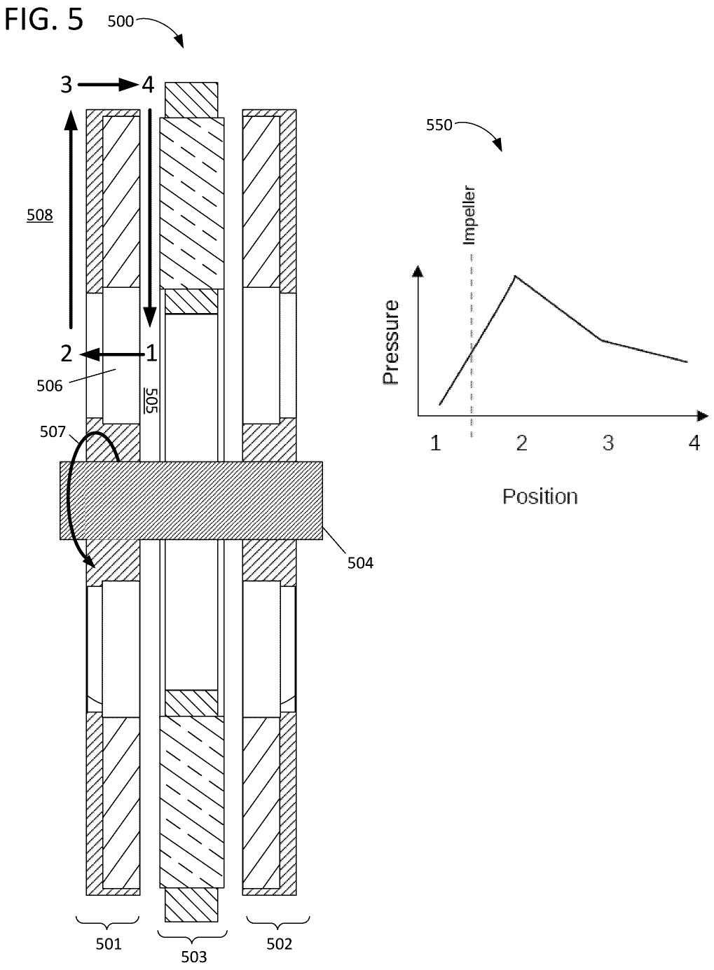

FIG. 5 illustrates radial cross section 500 of rotor 501, rotor 502, and stator 503 along with plot 550 of pressure values at various positions in radial cross section 500 in accordance with specific embodiments of the invention. Rotors 501 and 502 may include aspects of rotor 200, rotor 300, or a combination thereof. Rotor 501 may include impeller 506. Impeller 506 may include a rotor gap and an airfoil element. Rotor 502 may include a similar impeller. As illustrated, rotor 501 is spinning in a counterclockwise direction 507 from the perspective of stator 503, with the rotation centered on shaft 504. As a result, a pressure drop is formed across a surface of rotor 501 such that the highest pressure is at the back side of rotor 501 near the center of rotor 501 as shown by the number 2 in the figure. The result is airflow 508 from an outer edge of rotor 501, through the air gap 505, and out to the back side at the center of rotor 501. In other words, air may flow in a loop via number 3, number 4, number 1, number 2, and back to number 3 respectively. The path from number 4 to number 1 may include air gap 505. The path from number 1 to number 2 may include air flowing through a window of impeller 506. Airflow 508 may cool stator 503, for example by transferring heat from stator 503 to a motor housing (not shown). Rotor 502 may function similarly to rotor 501.

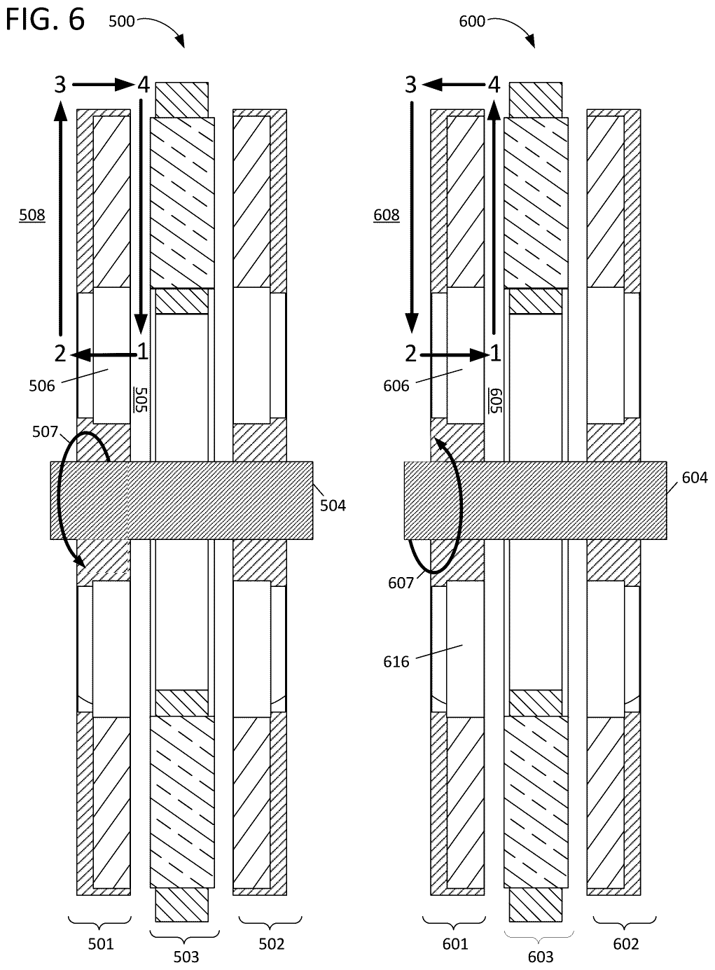

FIG. 6 illustrates radial cross section 500 (e.g., from FIG. 5) and radial cross section 600 showing how the direction of rotation of the rotor impacts the direction of airflow in accordance with specific embodiments of the invention. Radial cross section 500 shows rotor 501 spinning in a counterclockwise direction 507 from the perspective of stator 503. Radial cross section 600 may include aspects of radial cross section 500, with a principle difference being that rotor 601 is spinning in a clockwise direction 607 (e.g., opposite of direction 507) from the perspective of stator 603. For example, radial cross section 600 includes rotor 601, rotor 602, stator 603, shaft 604, air gap 605, and impeller 606. Impeller 606 may include a window and an airfoil element.

As illustrated, rotor 601 is spinning in a clockwise direction 607 from the perspective of stator 603. The result is airflow 608 from the back side at the center of the rotor, through the air gap, and out at an outer edge of the rotor. In other words, air may flow in a loop via number 2, number 1, number 4, and number 3, and back to number 2 respectively. The path from number 2 to number 1 may include air flowing through a window of impeller 606. The path from number 1 to number 4 may include air gap 605. Airflow 608 may cool stator 603, for example by transferring heat from stator 603 to a motor housing (not shown). Rotor 602 may function similarly to rotor 601.

In specific embodiments of the invention, the airfoil elements (e.g., of impeller 506 or impeller 606) can be configured to form a pressure drop gradient a surface of the rotor when the rotor rotates in either direction (e.g., direction 507 or direction 607) and at different speeds. These embodiments can help to provide cool air to the air gap even when the electric axial machine is run in reverse or when it is run at less than full speed. In specific embodiments of the invention, the airfoil elements will be configured to provide more airflow when the axial machine is run in a primary direction (e.g., direction 607) at the expense of less airflow when the axial machine is run in a secondary direction (e.g., direction 507). Examples of applications in which these embodiments would be beneficial are those in which the electric axial machine powers a vehicle that primarily traverses in a forward direction.

In specific embodiments, the impellers on a rotor can include a set of impellers where at least one impeller is configured to create a greater airflow at a first rotation speed as compared to at least one other impeller, where that other impeller is configured to create a greater airflow at a second rotation speed as compared to the at least one impeller. For example, rotor 601 may include impeller 606 and impeller 616. Impeller 606 could include a first airfoil element, and impeller 616 could include a second airfoil element. In this example, the first airfoil element could have a higher attack angle than the second airfoil element, the first airfoil element (of impeller 606) could cause a higher-pressure gradient than the second airfoil element (of impeller 616) at low speeds, and the second airfoil element (of impeller 616) could causes a higher pressure gradient than the first airfoil element (of impeller 606) at higher speeds. The higher speed being higher than the low speed and the low speed being lower than the high speed. In specific embodiments, the low speed can be less than 500 RPM and the high speed can be higher than 1,000 RPM. In specific embodiments, there may be more than two impellers on a rotor and there may be more than two attack angles of airfoil elements of the impellers. In specific embodiments, various impellers on a single rotor can be configured for the optimal creation of a pressure gradient at various speeds.

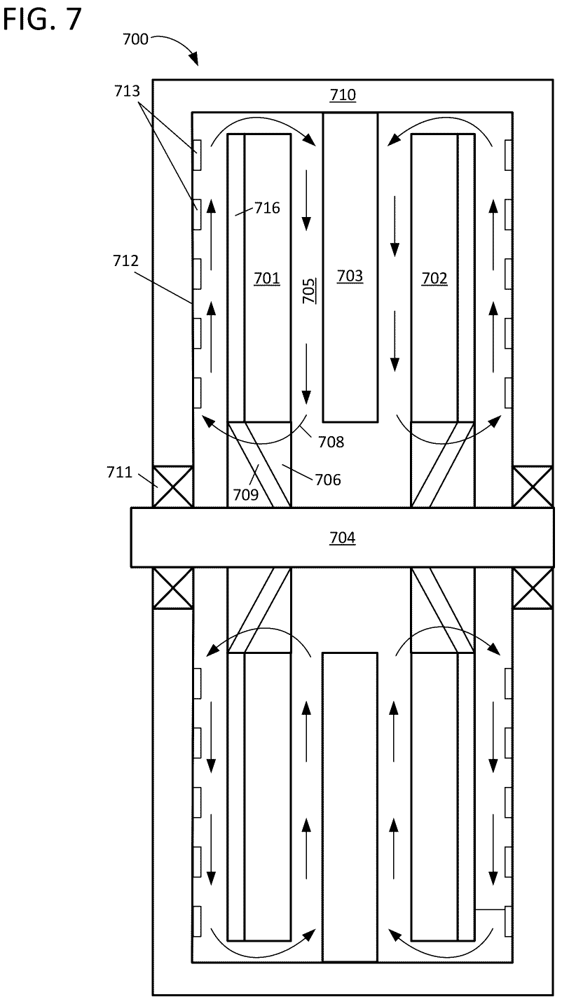

FIG. 7 illustrates radial cross section 700 of an axial flux electric machine with rotor 701, rotor 702, and stator 703 showing the direction of airflow through the system while rotors 701 and 702 are rotating in accordance with specific embodiments of the invention. Radial cross section 700 includes motor housing 710, bearing 711, and shaft 704. Rotor 701 includes impeller 706 with chamfered edge 709 and structural support (e.g., back iron disc) 716. Rotor 701 may include magnet sets. Motor housing 710 includes thermal features 713 and (internal) surface 712. Rotor 702 may function similarly to rotor 701. Each rotor may have rotational symmetry or be close to rotationally symmetric (e.g., have different angles of attack on the different impellers).

As illustrated, the airflow created by the impellers on rotors 701 and 702 transfers heat from the respective air gaps to the motor housing, as air is circulated through the respective air gap and then along a surface of the motor housing. For example, impeller 706 contributes to airflow 708 that transfers heat from air gap 705 to surface 712 of motor housing 710. With impellers on both rotor 701 and rotor 702, both sides of stator 703 are cooled in this fashion and motor housing 710 is exposed to twice the degree of contact between the fluid flow through the air gap thereby effectively doubling the thermal conductivity of that heat transfer path system compared to a motor with a single rotor.

A set of thermal features 713 can be formed on motor housing 710 and may be configured to increase turbulence and a surface area of the motor housing 710. For example, thermal features 713 may be formed along surface 712. Thermal features 713 may be on both the left and right sides of motor housing 710, and may be evenly spaced, randomly spaced, or distributed according to a pattern. Thermal features 713 may maximize the degree of interaction between the fluid flow (e.g., airflow 708 and other airflows) and the motor housing 710. The set of thermal features 713 can be fins, pins, or a combination thereof. The fins and pins can have various geometries including straight or curved and may have any height, thickness, width, length, diameter, shape, etc. In specific embodiments, the set of thermal features can be dimples formed in the surface of motor housing 710. Airflow 708 caused by impeller 706, and improved by thermal features 713, may cool stator 703, improving the life of the motor, expanding its operating ambient temperature range, and reducing the resistivity of conductive materials (e.g., making the motor more power efficient).

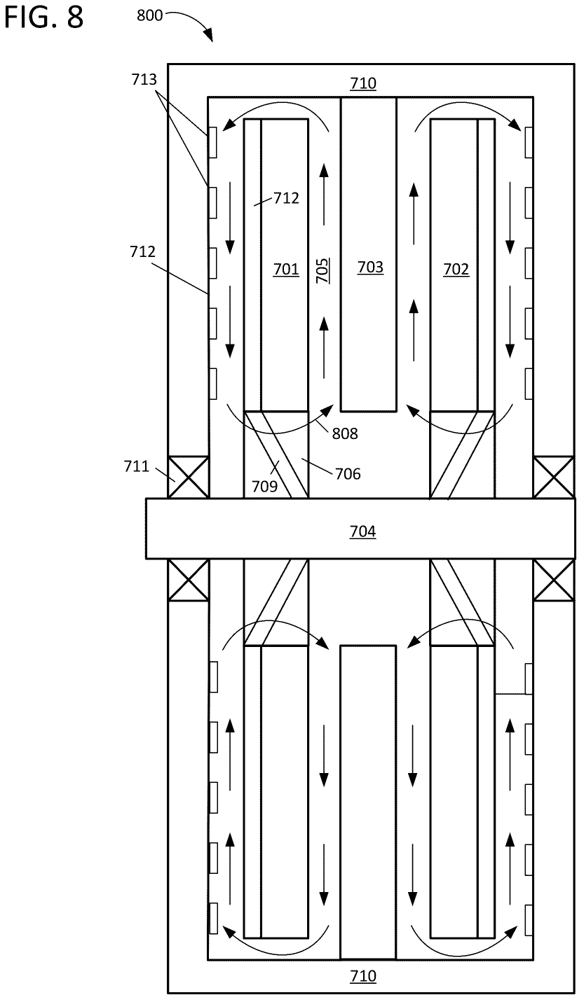

FIG. 8 illustrates a radial cross section 800 of the axial flux electric machine of FIG. 7, but with rotor 701 and rotor 702 spinning in a direction opposite to that of FIG. 7 in accordance with specific embodiments of the invention. Accordingly, airflow 808 is in the opposite direction as airflow 708. Other airflows depicted in FIG. 8 are likewise reversed relative to FIG. 7.

In specific embodiments of the invention, the impellers (e.g., impeller 706) can be configured to form a pressure drop gradient a surface of the rotor (e.g., rotor 701) when the rotor rotates in either the direction of FIG. 7 or the of FIG. 8 and at different speeds. These embodiments can help to provide cool air to the air gap (e.g., air gap 705) even when the electric axial machine is run in reverse or when it is run at less than full speed. In specific embodiments of the invention, the impellers may be configured to provide more airflow when the axial machine is run in a primary direction at the expense of less airflow when the axial machine is run in a secondary direction. In other words, airflow 708 may be stronger than airflow 808. For a vehicle (powered by an electric axial machine) that primarily traverses in a forward direction, a stronger airflow of a primary rotor direction may be beneficial even when the stronger airflow is at the expense of a weaker airflow of a secondary rotor direction.

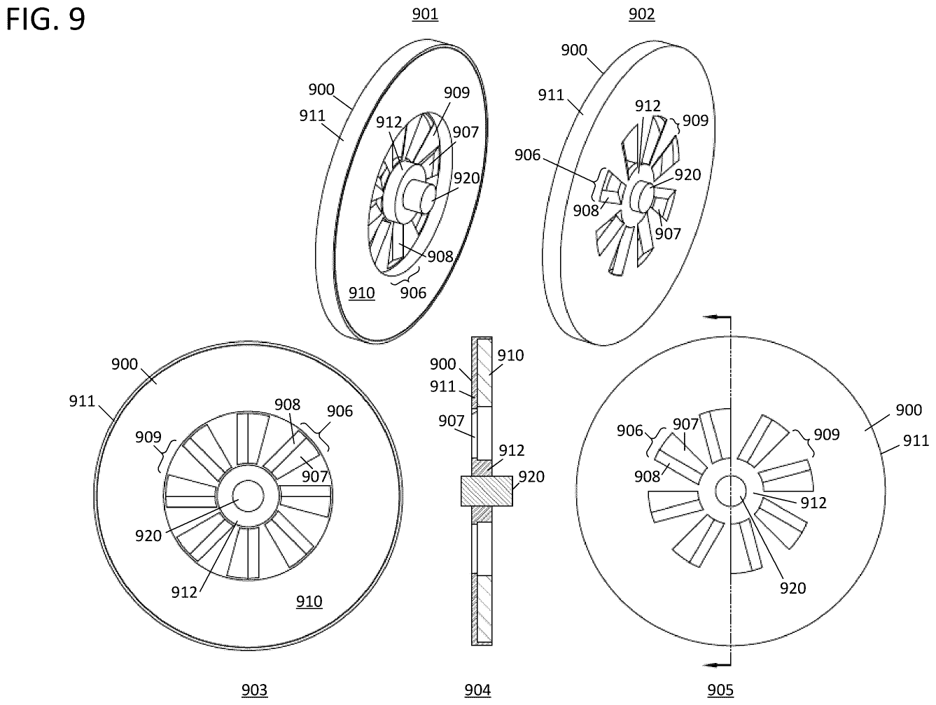

FIG. 9 illustrates rotor 900 with impellers 906 in the form of windows 907 and airfoil elements 908 comprising chamfered edges of windows 907 in accordance with specific embodiments of the invention. Rotor 900 also includes shaft 920, outer disc 910, rotor arms 909, inner disc 912, and back iron 911. FIG. 9 shows rotor 900 in views 901, 902, 903, 904, and 905. Examples of impellers 906, windows 907, airfoil elements 908 and rotor arms 909 are indicated in views 901 through 905. View 904 is a center-sliced view of view 905, looking left.

In the example of FIG. 9, rotor 900 includes eight windows 907. The chamfered edges and windows 907 combine to take up a majority of the arc of rotor 900 with thin arms 909 of rotor material forming connections with the outer disc 910 and inner disc 912 of rotor 900. Along the chamfered edge of the channel (e.g., airfoil element 908), the strength (e.g., thickness) of the rotor material increases from the edge of window 907 to thin arm 909 of rotor material.

In specific embodiments, rotor arms 909 may also be part of airfoil elements 908. For example, a rotor arm 909 and an airfoil element 908 may be combined into a sing element similar to a blade of a fan. In specific embodiments, airfoil elements 908 may be a tilted or angled plane of material connecting inner disc 912 to outer disc 910. Impellers 906 on rotor 900 may cool the axial flux electric machine to which it is a part. Accordingly, impellers 906 may prolong the life of the axial flux electric machine, expand the operating ambient temperature range, reduce the resistivity of the conductors, and increase the efficiency of the machine. These improvements may come without increasing the weight of rotor 900.

FIG. 10 illustrates rotor 1000 with impellers 1006 in the form of windows 1007 and airfoil elements 1008 comprising chamfered edges of the windows 1007 and chamfered channels that extend from windows 1007 to outer edge 1011 of rotor 1000 in accordance with specific embodiments of the invention. In the illustrated example, air is able to move all the way from the support structure (e.g., back iron) 1016 that attaches rotor 1000 to the machine shaft and out through an outer edge 1011 of rotor 1000. Rotor 1000 includes grooves 1013 (e.g., ridges) in outer edge 1011, some of which are aligned with airfoil elements 1008 while other grooves 1013 are not. Grooves 1013 may enhance the airflow in the system. In the example of FIG. 10, rotor 1000 includes eight impellers 1006 with eight windows 1007 and eight airfoil elements 1008. Outer edge 1011 may be part of support structure 1016. Rotor 1000 may be part of an axial flux electric machine. Impellers 1006 on rotor 1000 may cool the axial flux electric machine. Accordingly, impellers 1006 may prolong the life of the axial flux electric machine, expand the operating ambient temperature range, reduce the resistivity of the conductors, and increase the efficiency of the machine. These improvements may come without increasing the weight of rotor 1000.

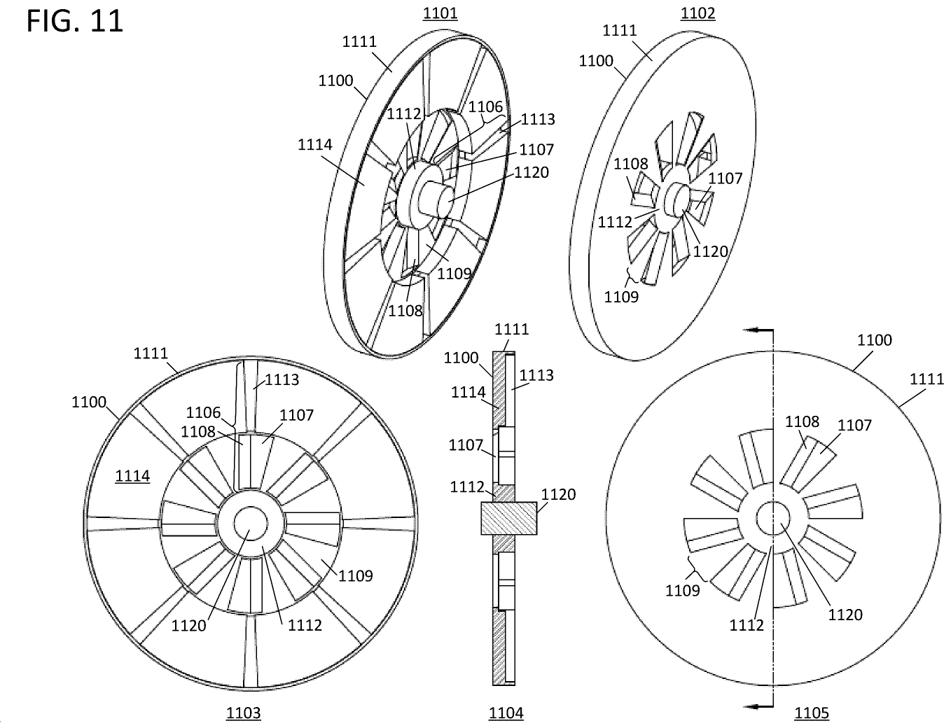

FIG. 11 illustrates rotor 1100 with segmented magnets 1114 and impellers 1106 in the form of windows 1107 and airfoil elements 1108 that extend from a center (e.g., shaft 1120) of rotor 1100 towards outer edge 1111 of rotor 1100 and between magnets 1114 in the set of segmented magnets 1114 in accordance with specific embodiments of the invention. FIG. 11 shows rotor 1100 in views 1101, 1102, 1103, 1104, and 1105. Examples of impellers 1106, windows 1107, airfoil elements 1108 and rotor arms 1109 are indicated in views 1101 through 1105. View 1104 is a center sliced view of view 1105, looking left.

In the example of FIG. 11, rotor 1100 includes eight windows 1107. The chamfered edges (e.g., airfoil elements 1108) and windows 1107 combine to take up a majority of the arc of rotor 1100 with thin arms 1109 of rotor material forming connections with the outer disc (e.g., containing magnets 1114) and inner disc 1112 of rotor 1100. In specific embodiments, along the chamfered edge of airfoil element 1108, the strength (e.g., thickness) of the rotor material may increase from the edge of window 1107 to thin arm 1109 of rotor material.

Rotor 1100 includes a set of segmented magnets 1114 and channels 1113 between magnets 1114. As illustrated, impellers 1106 include a set of airfoil elements 1108 which extend from a center of rotor 1100 towards outer edge 1111 of rotor 1100 and between magnets 1114. In addition to other benefits discussed, the illustrated approach is beneficial in that channels 1113 between the magnets 1114 help to agitate the air and create a pressure difference and also assist with excessive strain forming on the magnets 1114 as rotor 1100 rotates at high speeds.

FIG. 12 illustrates rotor 1200 with impellers 1206 in the form of windows 1207 and airfoil elements 1208 that extend from rotor 1200 in a direction that is away from the stator in accordance with specific embodiments of the invention. FIG. 12 shows rotor 1200 in views 1201, 1202, 1203, 1204, and 1205. Examples of impellers 1206, windows 1207, and airfoil elements 1208 are indicated in views 1201 through 1205. View 1204 is a center sliced view of view 1205, looking left.

The illustrated impellers 1206 include chamfered edges 1220 of the windows 1207 as well as airfoil elements 1208 in the form of blocks of material added to a back side of rotor 1200 in the form of a set of cuboids. As shown, the cuboids extend away from the direction of the stator in order to avoid interfering with the flow of air in the air gap. These cuboids also create a pressure gradient between the center of the rotor back plate 1221 and the outer edge 1211 of the rotor back plate 1221 while rotor 1200 is rotating. This pressure gradient may help cool the stator.

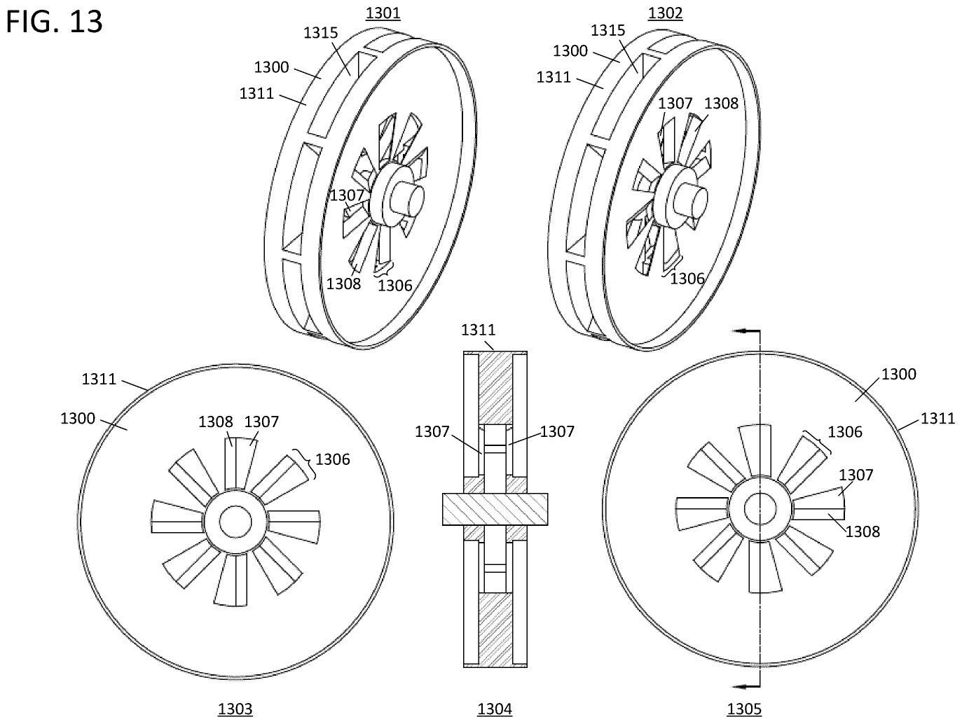

FIG. 13 illustrates rotor 1300 that is double sided where rotor gap 1315 extends through both sides of rotor 1300 into a cavity and outside edge 1311 of rotor 1300, and rotor gap 1315 includes at least one window 1307 for the cavity in accordance with specific embodiments of the invention. FIG. 13 shows rotor 1300 in views 1301, 1302, 1303, 1304, and 1305. Examples of impellers 1306, windows 1307, airfoil elements 1308, and rotor gap 1315 are indicated in views 1301 through 1305. View 1304 is a center sliced view of view 1305, looking left.

In the illustrated case, windows 1307 (e.g., holes) formed in either side of rotor 1300 are aligned and create a fluid flow path through windows 1307. However, in alternative embodiments, a single rotor gap can be formed by two windows (e.g., holes) that are not aligned so long as there is a fluid flow path through the two windows from one side of the rotor to the other. In either embodiment, the resulting fluid flow path may cool one or more stators associated with rotor 1300.

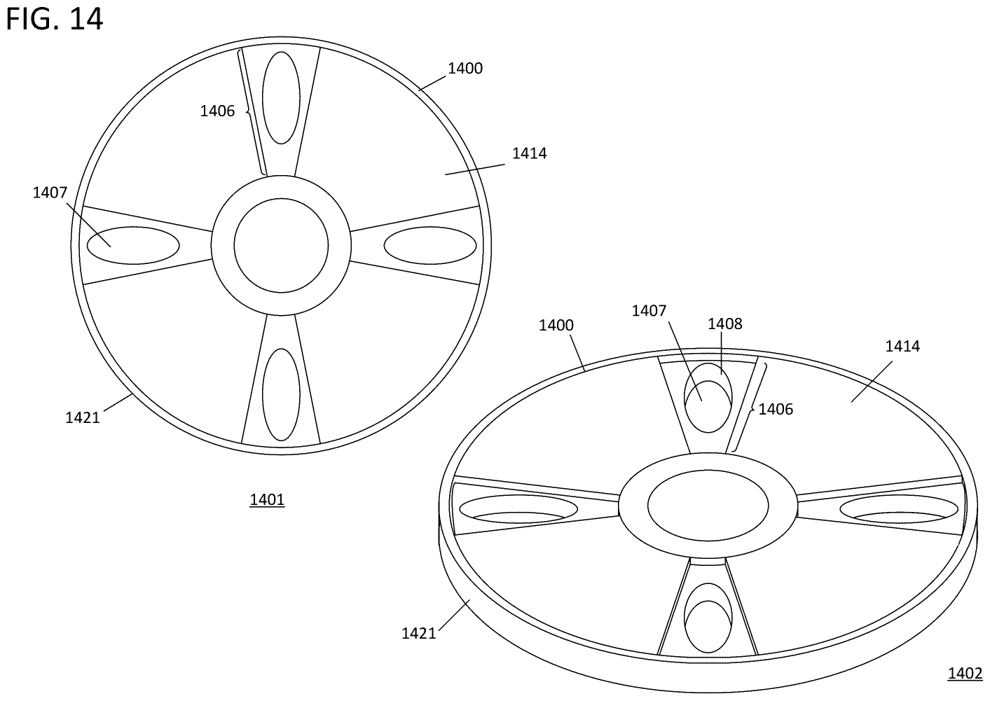

FIG. 14 illustrates rotor 1400 with magnets 1414 and impellers 1406 in the form of windows 1407 and airfoil elements 1408 including chamfered edges surrounding windows 1407 in accordance with specific embodiments of the invention. Magnets 1414 may be segmented. Rotor 1400 includes magnets 1414 and impellers 1406 between magnets 1414 (e.g., between pairs of magnets). As depicted, impellers 1406 and magnets 1414 alternate to be every other feature. In specific embodiments, impellers and magnets may be arranged such that two magnets are side by side and two impellers are side by side. In specific embodiments, impellers 1406 may also include indentations in rotor 1400 surrounding windows 1407. Windows 1407 may include chamfered edges, beveled edges, or another edge-type. Examples of impellers 1406, windows 1407, airfoil elements 1408, and magnets 1414 are indicated in view 1401 and view 1402. In the example of FIG. 14, rotor 1400 includes back iron 1421, four magnets 1414 (e.g., or four sets of magnets), and four impellers 1406 with four windows 1407 and four airfoil elements 1408. In specific embodiments, along the chamfered edge of airfoil element 1408, the strength (e.g., thickness) of the rotor material may increase from the edge of window 1407 to an arm of rotor material. Impellers 1406 on rotor 1400 may cool the axial flux electric machine. Accordingly, impellers 1406 may prolong the life of the axial flux electric machine, expand the operating ambient temperature range, reduce the resistivity of the conductors, and increase the efficiency of the machine. These improvements may come without increasing the weight of rotor 1400.

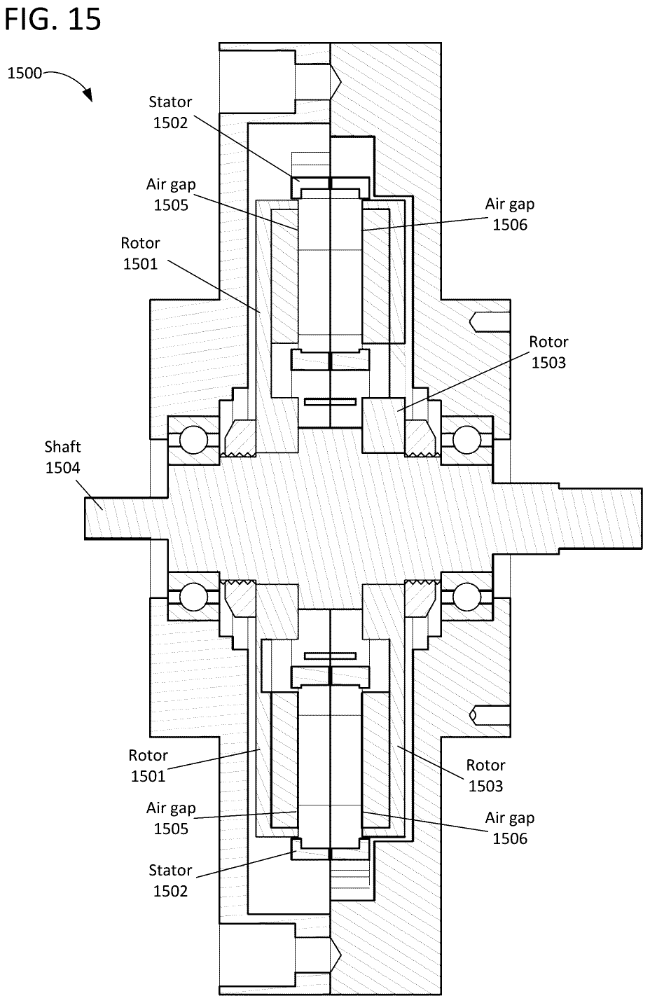

FIG. 15 illustrates a radial cross section of motor assembly 1500 having rotor 1501 and rotor 1503 on either side of stator 1502 and attached to rotor shaft 1504 in accordance with specific embodiments of the invention. In specific embodiments, motor assembly 1500 is yokeless. Using the approaches disclosed herein, both rotors 1501 and 1503 can include impeller elements and be used to increase a degree of airflow through the air gaps 1505 and 1506 between respective rotors 1501 and 1503 and stator 1502. For example, rotor 1501 includes impeller elements to increase airflow through air gap 1506. As a result of there being two rotors (one on each side of stator 1502), the degree by which stator 1502 is cooled is doubled leading to improved thermal performance. In specific embodiments, a fan may be attached to shaft 1504.

In specific embodiments, rotor 1501 and rotor 1503 each have a pair of rotor magnets and each rotor 1501 and rotor 1503 is paired with stator 1502. Each rotor 1501 and 1503 may include a set of impellers. The sets of impellers may be associated independently with the two rotor magnets in the pair of rotor magnets. Alternatively, rotors 1501 and 1503 may include a single set of impellers associated with the outer of the two rotor magnets. In either case, airflow through the air gaps (e.g., air gaps 1505 and 1506) between the rotor magnets and stator 1502 can be increased for improved thermal performance.

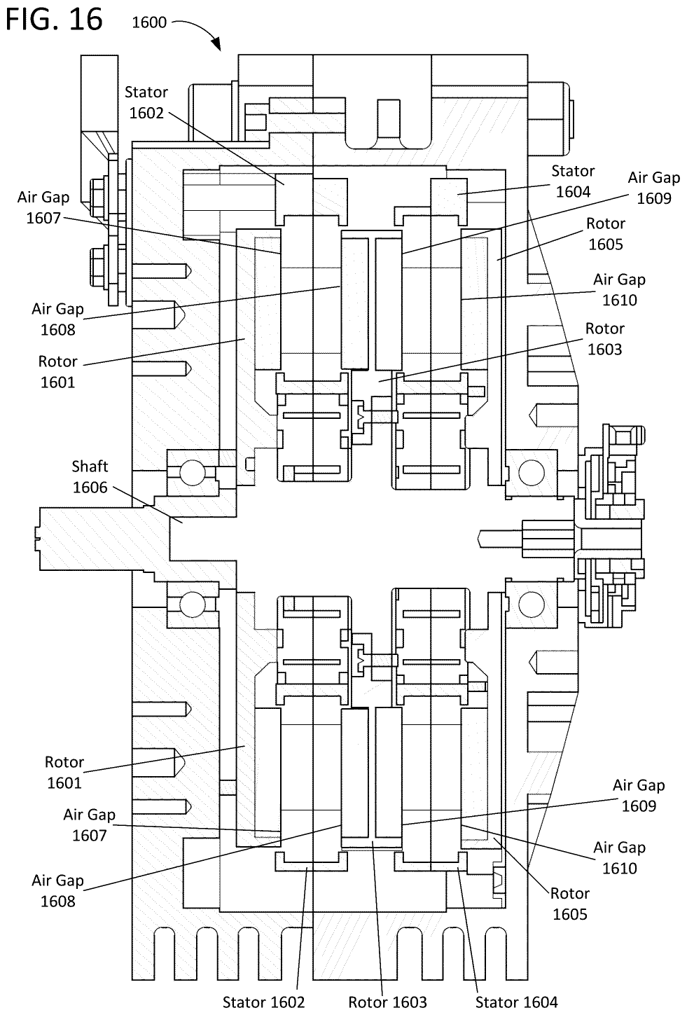

FIG. 16 illustrates a radial cross section of motor assembly 1600 having rotor 1601, rotor 1603, and rotor 1605, each with a pair of rotor magnets, on either side of stators 1602 and 1604 in accordance with specific embodiments of the invention. In specific embodiments, motor assembly 1600 is yokeless. Rotors 1601, 1603, and 1605 and stators 1602 and 1604 are attached to rotor shaft 1606. Motor assembly 1600 may refer to a tandem axial electric motor. In specific embodiments, each rotor 1601, 1603, and 1605 has a set of impellers. In other embodiments, one or more rotors of rotors 1601, 1603, and 1605 may not have impellers. Impellers may include airfoil elements. Airfoil elements may also be referred to as airfoil guide elements, as airfoil elements may guide air towards an air gap (e.g., air gaps 1607 through 1610). In specific embodiments, a fan may be attached to shaft 1606.

Air gap 1607 lies between rotor 1601 and stator 1602. Rotor 1603 is spaced apart from the stator 1602 in the axial direction to form air gap 1608, wherein air gap 1607 and air gap 1608 are on opposite sides of stator 1602. Airfoil elements on rotor 1601 may be configured to form a pressure gradient (e.g., pressure drop) across a surface of rotor 1601 and a first surface of rotor 1603 when rotor 1601 rotates.

Similarly, rotor 1603, stator 1604, and rotor 1605 are arranged to form air gap 1609 (between rotor 1603 and stator 1604) and air gap 1610 (between stator 1604 and rotor 1605). Airfoil elements on rotor 1605 may be configured to form a pressure gradient (e.g., a pressure drop) across a surface of rotor 1605 and a second surface of rotor 1603 when rotor 1605 rotates. Rotor 1603 may be double sided as it includes magnets on both sides in the axial direction such that it can be influenced by the magnetic fields generated by stators 1602 and 1604 on either side of rotor 1603.

Using the approaches disclosed herein, the illustrated rotors 1601, 1603, and 1605 can include sets of impellers. The sets of impellers of each rotor 1601, 1603, and 1605 can be associated independently with the two rotor magnets in the pair of rotor magnets of each rotor 1601, 1603, and 1605. For example, a set of impellers of rotor 1601 may be associated with each rotor magnet of the pair of rotor magnets of rotor 1601. Alternatively, rotors 1601, 1603, and 1605 can include a single set of impellers associated with the outer of the two rotor magnets. For example, rotor 1601 may include a set of impellers associated with the outer magnet of the pair of rotor magnets of rotor 1601. Regardless of how the impellers are arranged, airflow through the air gaps (e.g., air gaps 1607, 1608, 1609, and 1610) between the rotor magnets and the stators 1602 and 1604 can be increased (e.g., via the impellers) for improved thermal performance.

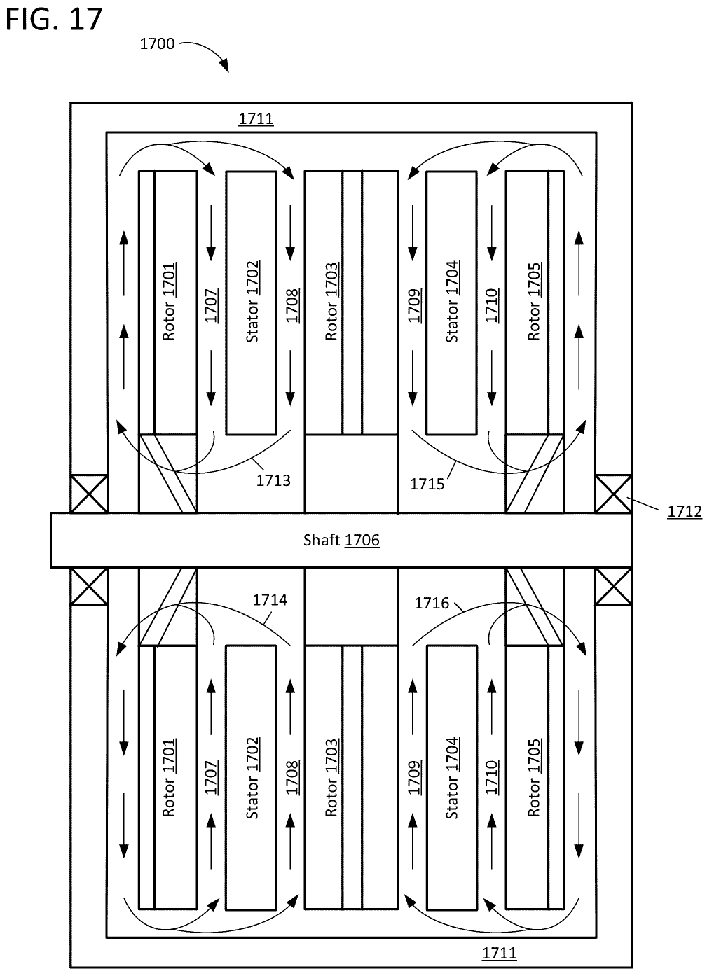

FIG. 17 illustrates a radial cross section of motor assembly 1700 including three rotors 1701, 1703, and 1705 on either side of two stators 1702 and 1704 and attached to rotor shaft 1706 and showing the direction of airflow through the system while the three rotors 1701, 1703, and 1705 are rotating in accordance with specific embodiments of the invention. Motor assembly 1700 may refer to a tandem axial electric motor and includes motor housing 1711 and bearings 1712. Each rotor 1701, 1703, and 1705 includes a back iron or support structure. In specific embodiments, a fan may be attached to shaft 1706.

Motor assembly 1700 includes rotor 1701 spaced apart from stator 1702 in the axial direction to form air gap 1707. Motor assembly 1700 also includes rotor 1703 spaced apart from stator 1702 in the axial direction to form air gap 1708, where air gap 1707 and air gap 1708 are on opposite sides of stator 1702. The airfoil elements on rotor 1701 are configured to form a pressure gradient across a surface of rotor 1703 when rotor 1701 rotates. This is shown by the third column of arrows from the left in FIG. 17 (as part of airflow 1713 and airflow 1714).

Rotor 1703 is double sided as it includes magnets on both sides in the axial direction such that it can be influenced by the magnetic fields generated by stator 1702 and stator 1704 on either side of rotor 1703. Furthermore, in addition to the rotor 1701 and rotor 1703, motor assembly 1700 includes rotor 1705 spaced apart from stator 1704 in the axial direction to form air gap 1710. Rotor 1703 is spaced apart from stator 1704 in the axial direction to form air gap 1709. Rotor 1705 can be configured similarly to rotor 1701. Rotor 1705 can include at least one additional impeller. The term additional is used here to reference the fact that rotor 1705 includes its own separate impellers as compared to those of rotor 1701. The at least one additional impeller is configured to form a pressure drop across a surface of rotor 1705 and a second surface of rotor 1703 when rotor 1705 rotates. This is shown by the second and third columns of arrows from the right in FIG. 17 (as part of airflow 1715 and airflow 1716).

In accordance with specific embodiments of the inventions, airflows 1713, 1714, 1715, and 1716 caused by impellers on rotors 1701, 1703, and 1705 may cool stators 1702 and 1704. Cooling stators 1702 and 1704 may prolong the life of insulation layers that separate winding turns from each other. As a result, the life of motor assembly 1700 may be prolonged and the temperature range at which motor assembly 1700 may function or operate may be increased. Additionally, reducing the temperatures of stators 1702 and 1704 may reduce the resistivity of conductors in motor assembly 1700, reducing joule losses. Overall, impellers (e.g., windows, airfoil elements, channels, etc.) may increase power density and torque density in motor assembly 1700.

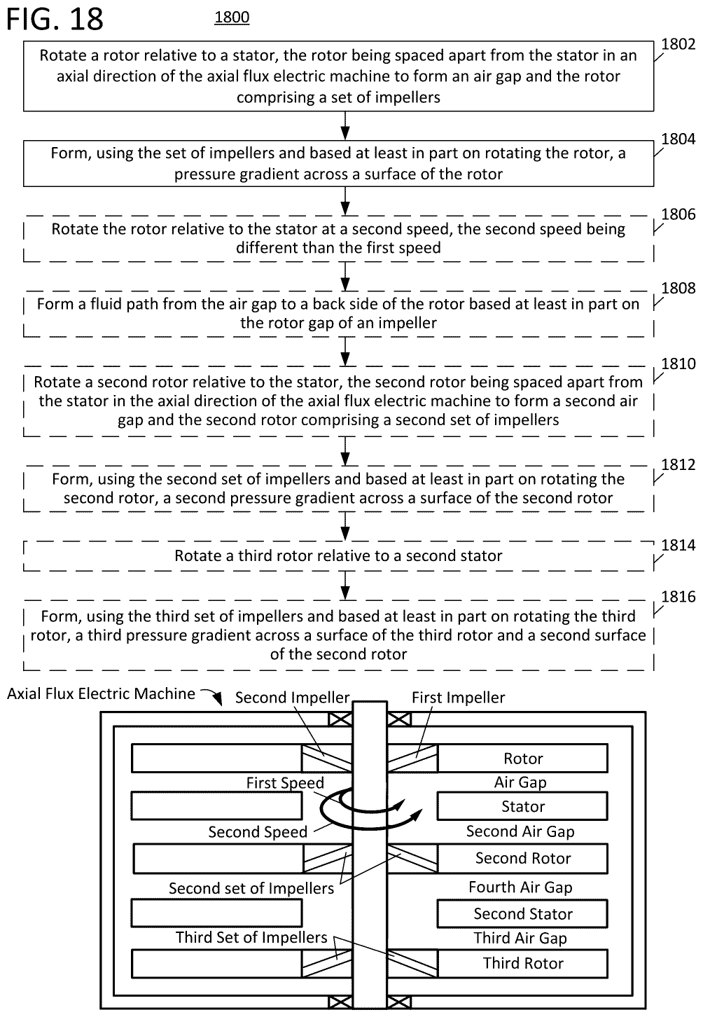

FIG. 18 illustrates method 1800 for cooling an axial flux electric machine. Method 1800 may be performed by or on a system including at least one stator, at least one rotor, a rotor shaft, and at least one impeller on the at least one rotor. In specific embodiments, a fan may be attached to the rotor shaft. In specific embodiments, steps or portions of steps of method 1800 may be omitted, duplicated, rearranged, or otherwise deviate from the method as shown.

At step 1802, a rotor may be rotated relative to a stator. The rotor may be spaced apart from the stator in an axial direction of the axial flux electric machine to form an air gap. The rotor may include a set of (e.g., one or more) impellers. In specific embodiments, the set of impellers may include a first impeller and a second impeller. Each impeller of the set of impellers may include an airfoil element, a rotor gap through the rotor, or a combination thereof. In specific embodiments, the rotor gap may be a window through the rotor and the airfoil element may be a chamfered edge of the window. In specific embodiments, the rotor may rotate at a first speed.

At step 1804, a pressure gradient may be formed across a surface of the rotor. The pressure gradient may be formed using the set of impellers and based on rotating the rotor (e.g., at step 1802). In specific embodiments, the pressure gradient is formed via the airfoil element of an impeller. In specific embodiments, at the first speed, the first impeller forms a first pressure gradient, and the second impeller forms a second pressure gradient. The first pressure gradient may be higher than the second pressure gradient. That is, at the first speed, the first impeller may form a pressure gradient that is higher than the pressure gradient formed by the second impeller. In specific embodiments, the impellers are not interchangeable, meaning that different impellers may have different performances at a given speed or may be optimized for different speeds.

In specific embodiments, at step 1806, the rotor may rotate relative to the stator as a second speed. The second speed may be different than the first speed (e.g., from step 1802). In specific embodiments, at the second speed, the first impeller forms a third pressure gradient, and the second impeller forms a fourth pressure gradient. The fourth pressure gradient may be higher than the third pressure gradient. That is, at the second speed, the second impeller may form a pressure gradient that is higher than the pressure gradient formed by the first impeller. This is opposite the relative gradients at the first speed.

In specific embodiments, at step 1808, a fluid path from the air gap to a back side of the rotor may be formed. The fluid path may be formed via the rotor gap of an impeller.

In specific embodiments, at step 1810, a second rotor may be rotated relative to the stator. The second rotor may be spaced apart from the stator in the axial direction of the axial flux electric machine to form a second air gap. The second rotor may comprise a second set of (e.g., one or more) impellers.

In specific embodiments, at step 1812, a second pressure gradient may be formed across a surface of the second rotor. The second pressure gradient may be formed using the second set of impellers and based on the second rotor being rotated.

In specific embodiments, at step 1814, a third rotor may be rotated relative to a second stator. The third rotor may be spaced apart from the second stator in the axial direction to form a third air gap. The third rotor may include a third set of impellers. The second rotor may be double sided and may be spaced apart from the second stator in the axial direction to form a fourth air gap.

In specific embodiments, at step 1816, a third pressure gradient across a surface of the third rotor and a second surface of the second rotor may be formed. The third pressure gradient may be formed using the third set of impellers and based on rotating the third rotor.

In specific embodiments of the invention, the axial flux electric machine may include only one rotor and one stator. In other embodiments of the invention, the axial flux electric machine may include only one rotor and two stators, such that one stator is on one side of the rotor and the other stator is on the opposite side of the rotor. In alternative embodiments, the axial flux electric machine can include a larger number of rotors and stators which impart torque on a shared rotor shaft. In specific embodiments of the invention, two rotors that are driven by a single stator can distribute torque to two separate rotor shafts. In specific embodiments, two rotors that are driven by a single stator can be connected to a mechanical differential assembly such that they impart torque on a shared rotor shaft with two portions that can also be rotated independently of each other. In some embodiments, the rotor shaft is hollow. In some embodiments, the axial flux electric machine is yokeless.

In accordance with specific embodiments of the inventions, airflows formed or caused by one or more impellers on one or more rotors of an axial flux machine may cool one or more stators of the machine. Cooling the stators may prolong the life of insulation layers that separate winding turns from each other. As a result, the life of the axial flux machine may be prolonged and the ambient temperature range at which it may operate may be increased. Additionally, reducing the temperatures of the stators may reduce the resistivity of conductors in the machine, reducing joule losses. Overall, impellers (e.g., windows, airfoil elements, channels, etc.) may increase power density and torque density in the axial flux machine.

While the specification has been described in detail with respect to specific embodiments of the invention, it will be appreciated that those skilled in the art, upon attaining an understanding of the foregoing, may readily conceive of alterations to, variations of, and equivalents to these embodiments. Although examples in this disclosure included reference to airfoil elements, any elements that are configured to create turbulence in a volume of air (i.e., present an angle of attack to a direction of movement through a volume of air) can be used in place of the airfoil elements disclosed above in alternative embodiments. Such elements can be referred to as air agitation elements. Although examples in the disclosure were generally directed to axial flux electric machines in the form of axial flux motors, embodiments disclosed herein are equally applicable to axial flux generators. These and other modifications and variations to the present invention may be practiced by those skilled in the art, without departing from the scope of the present invention, which is more particularly set forth in the appended claims.

What is claimed is:

1. An axial flux electric machine comprising:
a stator;
a rotor spaced apart from the stator in an axial direction of the axial flux electric machine to form an air gap; and
at least one impeller on the rotor;
wherein the at least one impeller includes a rotor gap through the rotor and an airfoil element.

2. The axial flux electric machine of claim 1, wherein:
the axial flux electric machine is yokeless.

3. The axial flux electric machine of claim 1, wherein:
the at least one impeller is configured to form a pressure gradient across a surface of the rotor when the rotor rotates.

4. The axial flux electric machine of claim 1, wherein:
the airfoil element is configured to form a pressure gradient across a surface of the rotor when the rotor rotates; and
the rotor gap is configured to form a fluid path from the air gap to a back side of the rotor.

5. The axial flux electric machine of claim 1, further comprising:
a rotor shaft attached to the rotor; and
a fan attached to the rotor shaft.

6. The axial flux electric machine of claim 1, wherein:
the rotor gap and the airfoil element are formed on the rotor.

7. The axial flux electric machine of claim 1, further comprising:
a back iron of the rotor;
wherein the rotor gap comprises a window through the back iron.

8. The axial flux electric machine of claim 1, wherein:
the rotor gap is a window through the rotor; and
the airfoil element is a chamfered edge of the window.

9. The axial flux electric machine of claim 1, wherein:
the rotor gap is a window through the rotor; and
the airfoil element comprises a chamfered edge of the window and a chamfered channel that extends from the window to an outer edge of the rotor.

10. The axial flux electric machine of claim 1, wherein:
the airfoil element comprises an airfoil on an outer edge of the rotor.

11. The axial flux electric machine of claim 1, wherein:
the rotor gap is etched into the rotor; and
the airfoil element is attached to the rotor.

12. The axial flux electric machine of claim 1, comprising:
at least one other impeller on the rotor;
wherein: (i) the at least one other impeller includes a second airfoil element; (ii) the airfoil element has a higher attack angle than the second airfoil element; and (iii) the airfoil element causes a higher-pressure gradient than the second airfoil element at low speeds;
and (iv) the second airfoil element causes a higher pressure gradient than the airfoil element at higher speeds.

13. The axial flux electric machine of claim 1, further comprising:
a set of segmented magnets on the rotor;
wherein: (i) the at least one impeller includes a set of airfoil elements; and the set of airfoil elements extend from a center of the rotor towards an outer edge of the rotor and between magnets in the set of segmented magnets.

14. The axial flux electric machine of claim 1, wherein:
the at least one impeller comprises at least three rotor gaps; and
the at least three rotor gaps occupy at least thirty degrees of an arc of the rotor.

15. The axial flux electric machine of claim 1, wherein:
the airfoil element extends from the rotor in a direction that is away from the stator.

16. The axial flux electric machine of claim 1, wherein:
the rotor is double sided;
the rotor gap extends through both sides of the rotor into a cavity; and
an outside edge of the rotor includes at least one window for the cavity.

17. The axial flux electric machine of claim 1, further comprising:
a motor housing;
wherein airflow created by the at least one impeller transfers heat from the air gap to the motor housing.

18. The axial flux electric machine of claim 17, wherein:
the motor housing includes a set of pins or a set of fins; and
the airflow created by the at least one impeller transfers heat from the air gap to the motor housing via thermal contact between the air gap and the set of fins or the set of pins.

19. The axial flux electric machine of claim 17, further comprising:
a set of pins or a set of fins attached to the motor housing, wherein the airflow created by the at least one impeller transfers heat from the air gap to the motor housing via the set of fins or the set of pins.

20. The axial flux electric machine of claim 17, further comprising:
a set of thermal features on the motor housing that are configured to increase turbulence and a surface area of the motor housing.

21. The axial flux electric machine of claim 20, wherein:
the set of thermal features are one of straight fins, curved fins, straight pins, and curved pins.

22. The axial flux electric machine of claim 17, further comprising:
a set of airfoil guide elements on the motor housing;
wherein the set of airfoil guide elements are configured to guide air towards the air gap.

23. The axial flux electric machine of claim 1, further comprising:
a second rotor spaced apart from the stator in the axial direction to form a second air gap, wherein the air gap and the second air gap are on opposite sides of the stator;
wherein the airfoil element is configured to form a pressure gradient across a surface of the second rotor when the second rotor rotates.

24. The axial flux electric machine of claim 23, further comprising:
a third rotor spaced apart from a second stator in the axial direction to form a third air gap; and
at least one additional impeller on the third rotor;
wherein: (i) the second rotor is double sided and is spaced apart from the second stator in the axial direction to form a fourth air gap; and (ii) the at least one additional impeller is configured to form a pressure gradient across a surface of the third rotor and a second surface of the second rotor when the third rotor rotates.

25. An axial flux electric machine comprising:
a stator;
a rotor spaced apart from the stator in an axial direction of the axial flux electric machine to form an air gap;
a rotor shaft attached to the rotor; and
a fan attached to the rotor shaft and to the rotor.

26. A method for cooling an axial flux electric machine comprising:
rotating a rotor relative to a stator, the rotor being spaced apart from the stator in an axial direction of the axial flux electric machine to form an air gap and the rotor comprising a set of impellers; and
forming, using the set of impellers and based at least in part on rotating the rotor, a pressure gradient across a surface of the rotor.

27. The method of claim 26, wherein rotating the rotor comprises rotating the rotor at a first speed and further comprising:
rotating the rotor relative to the stator at a second speed, the second speed being different than the first speed.

28. The method of claim 27, wherein:
the set of impellers comprises a first impeller and a second impeller;
at the first speed, the first impeller forms a first pressure gradient and the second impeller forms a second pressure gradient, the first pressure gradient being higher than the second pressure gradient; and
at the second speed, the first impeller forms a third pressure gradient and the second impeller forms a fourth pressure gradient, the fourth pressure gradient being higher than the third pressure gradient.

29. The method of claim 26, wherein:
each impeller of the set of impellers comprises an airfoil element; and
the pressure gradient is formed based at least in part on the airfoil element of an impeller.

30. The method of claim 26, wherein each impeller of the set of impellers comprises a rotor
gap through the rotor, and further comprising:
forming a fluid path from the air gap to a back side of the rotor based at least in part on the rotor gap of an impeller.

31. The method of claim 26, wherein:
each impeller of the set of impellers comprises an airfoil element and a rotor gap;
the rotor gap is a window through the rotor; and
the airfoil element is a chamfered edge of the window.

32. The method of claim 26, further comprising:
rotating a second rotor relative to the stator, the second rotor being spaced apart from the stator in the axial direction of the axial flux electric machine to form a second air gap and the second rotor comprising a second set of impellers; and
forming, using the second set of impellers and based at least in part on rotating the second rotor, a second pressure gradient across a surface of the second rotor.

33. The method of claim 32, further comprising:
rotating a third rotor relative to a second stator, wherein (i) the third rotor is spaced apart from the second stator in the axial direction to form a third air gap, (ii) the third rotor comprises a third set of impellers, and (iii) the second rotor is double sided and is spaced apart from the second stator in the axial direction to form a fourth air gap; and
forming, using the third set of impellers and based at least in part on rotating the third rotor, a third pressure gradient across a surface of the third rotor and a second surface of the second rotor.
